(19) United States
(12) Patent Application Publication
(10) Pub. No.: US 2019/0257384 A1
(43) Pub. Date: Aug. 22, 2019

(54) ISOLATOR ASSEMBLY AND A VEHICLE INCLUDING THE ISOLATOR ASSEMBLY

(71) Applicant: GM Global Technology Operations LLC, Detroit, MI (US)

(72) Inventors: Dongxu Li, Troy, MI (US); Farzad Samie, Franklin, MI (US); Derek F. Lahr, Howell, MI (US)

(73) Assignee: GM Global Technology Operations LLC, Detroit, MI (US)

(21) Appl. No.: 15/899,423

(22) Filed: Feb. 20, 2018

(51) Int. Cl. F16F 15/14; F16D 7/02; F16F 15/30

(52) U.S. Cl. CPC F16F 15/145; F16D 7/02; F16F 2232/02; F16D 2300/22; F16F 15/30

(57) ABSTRACT

An isolator assembly includes a clutch configured to operate in a full locked condition. The isolator assembly also includes a first damper and a second damper configured to reduce oscillation when the clutch is in the full locked condition. The first and second dampers each include at least one plate and at least one spring. The isolator assembly further includes a centrifugal pendulum absorber (CPA) coupled to one of the first and second dampers. The CPA is configured to reduce oscillation when the clutch is in the full locked condition. A vehicle includes an engine and a transmission. The engine includes an output shaft and the transmission includes an input member. The vehicle includes the isolator assembly operable between the output shaft and the input member.

### INTRODUCTION

A vehicle can include an engine and a transmission coupled to the engine. Generally, the transmission is coupled to the engine to receive torque outputted from the engine. The vehicle can include a torque converter connected to an output shaft of the engine and an input member of the transmission. The torque converter can provide the desired multiplication of torque from the engine into the transmission.

### SUMMARY

The present disclosure provides an isolator assembly including a clutch configured to operate in a full locked condition. The isolator assembly also includes a first damper and a second damper configured to reduce oscillation when the clutch is in the full locked condition. The first and second dampers each include at least one plate and at least one spring. The isolator assembly further includes a centrifugal pendulum absorber (CPA) coupled to one of the first and second dampers. The CPA is configured to reduce oscillation when the clutch is in the full locked condition.

The isolator assembly optionally includes one or more of the following:

A) the first and second dampers are disposed in a series circuit arrangement relative to each other;

B) a pump and a turbine fluidly connected to the pump;

C) the pump is operable upstream from the clutch relative to the direction that torque is transferred across the isolator assembly;

D) the turbine is coupled to the plate of one of the first and second dampers;

E) an end plate disposed downstream from the first and second dampers relative to the direction that torque is transferred across the isolator assembly;

F) an inertia structure coupled to one of the first damper, the second damper and the end plate;

G) the inertia structure dampens oscillation when torque is transferred across the isolator assembly;

H) the inertia structure includes the turbine;

I) the inertia structure disposed upstream from the first and second dampers relative to the direction that torque is transferred across the isolator assembly;

J) the clutch is also configured to operate in a slip condition;

K) the first damper and the second damper are configured to reduce oscillation when the clutch is in one of the full locked condition and the slip condition;

L) the CPA is configured to reduce oscillation when the clutch is in one of the full locked condition and the slip condition;

M) the turbine is coupled to the end plate;

N) the pump and the turbine are rotatable at different speeds when the clutch is in the slip condition;

O) the clutch is operable in the full locked condition in which the clutch indirectly or directly locks the pump and the turbine together such that the pump and the turbine rotate at the same speed;

P) the CPA is directly coupled to the plate of the first damper upstream from the second damper relative to the direction that torque is transferred across the isolator assembly;

Q) the second damper is spaced from the CPA;

R) the CPA is further defined as a first CPA, and further including a second CPA spaced from the first CPA;

S) the first CPA is directly coupled to the plate of the first damper upstream from the second damper relative to the direction that torque is transferred across the isolator assembly;

T) the second CPA is directly coupled to the plate of the second damper downstream from the first damper relative to the direction that torque is transferred across the isolator assembly;

U) a third CPA spaced from the first and second CPAs, and the third CPA is directly coupled to the end plate;

V) the CPA is directly coupled to the plate of the second damper downstream from the first damper relative to the direction that torque is transferred across the isolator assembly;

W) the first damper is spaced from the CPA; and

X) the CPA is directly coupled to the end plate, and the first and second dampers are spaced from the CPA.

The present disclosure also provides a vehicle including an engine and a transmission. The engine includes an output shaft and the transmission includes an input member. The vehicle also includes an isolator assembly operable between the output shaft and the input member. The isolator assembly includes a clutch configured to operate in a full locked condition. The isolator assembly also includes a first damper and a second damper configured to reduce oscillation when the clutch is in the full locked condition. The first and second dampers each include at least one plate and at least one spring. The isolator assembly also includes a centrifugal pendulum absorber (CPA) coupled to one of the first and second dampers. The CPA is configured to reduce oscillation when the clutch is the full locked condition.

The vehicle optionally includes one or more of the following:

A) the output shaft, the first and second dampers and the input member are disposed in a series circuit arrangement relative to each other;

B) the CPA is directly coupled to the plate of the first damper upstream from the second damper relative to the direction that torque is transferred across the isolator assembly;

C) the second damper is spaced from the CPA;

D) the CPA is directly coupled to the plate of the second damper downstream from the first damper relative to the direction that torque is transferred across the isolator assembly;

E) the first damper is spaced from the CPA;

F) the isolator assembly includes an end plate disposed downstream from the first and second dampers relative to the direction that torque is transferred across the isolator assembly;

G) the isolator assembly includes an inertia structure coupled to one of the first damper, the second damper and the end plate;

H) the inertia structure dampens oscillation when torque is transferred across the isolator assembly;

I) the end plate is directly coupled to the input member, and the CPA is directly coupled to the end plate;

J) the first and second dampers are spaced from the CPA;

K) the isolator assembly includes a pump and a turbine fluidly connected to the pump, and the pump is operable upstream from the clutch relative to the direction that torque is transferred across the isolator assembly;

L) the inertia structure includes the turbine that is coupled to one of the first damper, the second damper, and the end plate; the clutch is also configured to operate in a slip condition;

M) the first damper and the second damper are configured to reduce oscillation when the clutch is in one of the full locked condition and the slip condition;

N) the CPA is configured to reduce oscillation when the clutch is in one of the full locked condition and the slip condition;

O) the CPA is further defined as a first CPA, and the isolator assembly includes a second CPA spaced from the first CPA;

P) the first CPA is directly coupled to the plate of the first damper upstream from the second damper relative to the direction that torque is transferred across the isolator assembly;

Q) the second CPA is directly coupled to the plate of the second damper downstream from the first damper relative to the direction that torque is transferred across the isolator assembly; and

R) the isolator assembly includes a third CPA spaced from the first and second CPAs, and the third CPA is directly coupled to the end plate.

The detailed description and the drawings or FIGS. are supportive and descriptive of the disclosure, but the claim scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic illustration of a vehicle including an isolator assembly.

FIG. 2 is a schematic illustration of the isolator assembly.

FIG. 3 is a schematic fragmentary cross-sectional view of part of a torque converter.

FIG. 4 is a schematic perspective view of part of a centrifugal pendulum absorber.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims.

Referring to the FIGS., wherein like numerals indicate like or corresponding parts throughout the several views, a vehicle 10 and an isolator assembly 12 are shown in FIG. 1.

The isolator assembly 12 can be utilized in a vehicle application or a non-vehicle application. Non-limiting examples of the vehicle 10 can include cars, trucks, all-terrain vehicles, off-road vehicles, recreational vehicles, aircrafts, boats, watercrafts, farm equipment or any other suitable movable platform. Additionally, the vehicle 10 can include autonomously driven vehicles or vehicles driven via a human. Furthermore, the vehicle 10 can be an electric vehicle, a hybrid vehicle or a traditional gas powered vehicle. Non-limiting examples of the non-vehicles can include machines, farm equipment or any other suitable non-vehicle.

Continuing with FIG. 1, the vehicle 10 can include an engine 14 and a transmission 16 coupled to the engine 14. Generally, the transmission 16 is coupled to the engine 14 to receive torque outputted from the engine 14. The engine 14 can be an internal combustion engine or any other suitable type of engine. The engine 14 can include an output shaft 18, and the transmission 16 can include an input member 20. The output shaft 18 of the engine 14 rotates at an engine speed 22 (see arrow 22 in FIG. 1), and torque from rotation of the output shaft 18 is transferred to the input member 20 of the transmission 16, which causes the input member 20 to rotate. The powertrain of the vehicle 10 can include one or more electric traction motors in an optional hybrid embodiment to provide additional sources of input torque. Non-limiting examples of the transmission 16 can include automatic transmission, dual clutch transmission, automated manual transmission, continuously variable transmission (CVT), manual transmission, etc.

Again continuing with FIG. 1, the transmission 16 can include a final drive 24 coupled to the input member 20 and an output member 26 that delivers output torque (see arrow 27 in FIG. 1) to one or more drive axles 29 through the final drive 24, and ultimately to a set of wheels 28. Therefore, torque from the engine 14 is transferred to the transmission 16, and the transmission 16 outputs torque to drive the wheels 28. It is to be appreciated that the final drive 24 can be driven by an endless rotatable member, and non-limiting examples of the endless rotatable member can include a belt or a chain.

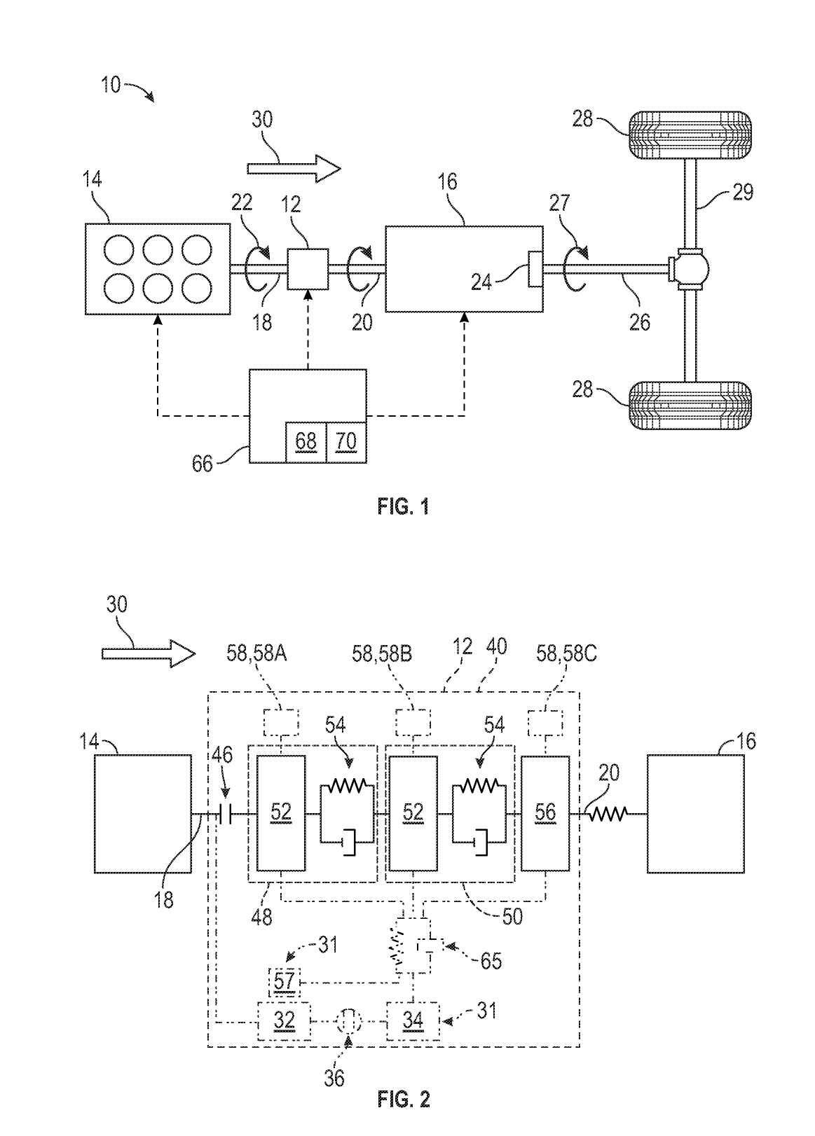

Referring to the FIGS. 1 and 2, the isolator assembly 12 can be utilized. In certain embodiments, the vehicle 10 can include the isolator assembly 12 described herein. In the vehicle application, the isolator assembly 12 is operable between the output shaft 18 and the input member 20. For example, the isolator assembly 12 can be connected to the output shaft 18 of the engine 14 and the input member 20 of the transmission 16. As such, the output shaft 18 of the engine 14 is rotatable to transfer torque in a direction to the input member 20 of the transmission 16 through the isolator assembly 12. Therefore, the direction that torque is transferred across the isolator assembly 12 is illustrated by arrow 30 (see FIGS. 1 and 2).

In certain embodiments, the isolator assembly 12 can be further defined as a torque converter. The torque converter can provide the desired multiplication of torque from the engine 14 into the transmission 16 at low speeds. As one non-limiting example, the torque converter can be utilized with an automatic transmission.

Operation of the engine 14 creates oscillations or inertia, which is transferred through the output shaft 18 to the isolator assembly 12. For example, as the engine 14 operates, vibrations are created by the moving parts, and sound is created at certain frequencies. Therefore, operation of the engine 14 outputs torque, which creates oscillations in the output shaft 18 and sound. The isolator assembly 12, as detailed below, reduces an amount of oscillation being outputted therefrom and can cancel sound at a predetermined frequency. For example, the operation of the engine 14, such as engine speed 22, causes sound to be created at various frequencies; and the isolator assembly 12 can operate to cancel a predetermined frequency of one of the frequencies from the operation of the engine 14. Furthermore, the isolator assembly 12 can also reduce the amount of oscillation transferred to the transmission 16. The isolator assembly 12, as detailed herein, can lower torsional forces directed to the transmission 16 from operation of the engine 14.

Referring to FIG. 2, the isolator assembly 12 can include an inertia structure 31 that dampens oscillation when torque is transferred across the isolator assembly. Operation of the engine 14, such as movement of the output shaft 18 of the engine 14, or oscillations or vibrations from the engine, can create torque that is applied to the inertia structure 31.

Furthermore, the isolator assembly 12 can optionally include a pump 32 and a turbine 34 fluidly connected to the pump 32. Hence, the pump 32 and the turbine 34 are operable through a fluid coupling 36, in which fluid that moves through the pump 32, due to rotation of the pump 32, is transferred to the turbine 34 which causes rotation of the turbine 34. Therefore, the pump 32 and the turbine 34 are each rotatable. The pump 32 and the turbine 34 can be rotatable concurrently or independently of each other, which will be discussed further below. More specifically, in certain embodiments, the torque converter can include the pump 32 and the turbine 34 discussed herein. In certain embodiments, the inertial structure 31 can include the turbine 34. Therefore, the turbine 34 has the inertia applied thereto.

Generally, in the vehicle application, the pump 32 is coupled to the output shaft 18 of the engine 14, and the turbine 34 is coupled to the input member 20 of the transmission 16. Therefore, in certain embodiments, the pump 32 can be operable upstream from the turbine 34 relative to the direction that torque is transferred across the isolator assembly 12.

A fluid is transferable from the pump 32 to the turbine 34, and back again to the pump 32, in a loop during rotation of the pump 32 and the turbine 34. The fluid can be a liquid fluid, and non-limiting examples of the liquid fluid can include transmission fluid, oil, synthetic oil, etc.

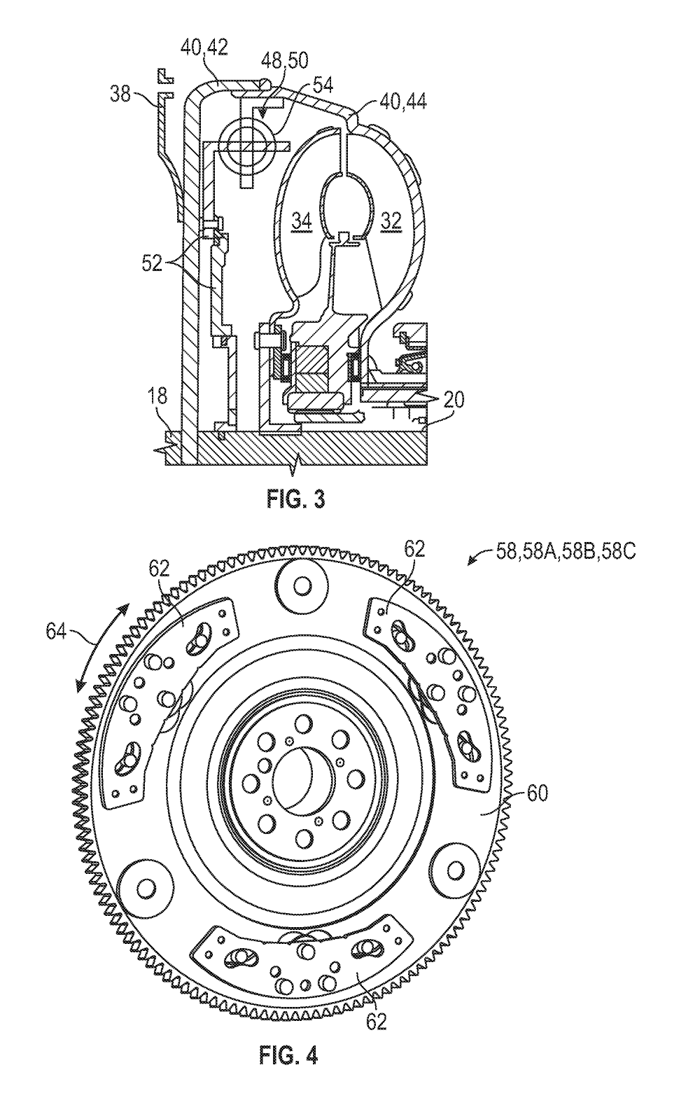

The engine 14 can include a plate 38 (see FIG. 3) fixed to the output shaft 18 (of the engine 14). The plate 38 of the engine 14 can be directly or indirectly fixed to the output shaft 18. Therefore, the plate 38 of the engine 14 and the output shaft 18 are rotatable concurrently. As such, the plate 38 of the engine 14 rotates at the same speed as the output shaft 18. The plate 38 of the engine 14 can be referred to as a flywheel, a drive plate or a flex plate.

As best shown in FIG. 3, the isolator assembly 12 can include a casing 40. The casing 40 can be fixed to the plate 38 of the engine 14 either directly or indirectly. In certain embodiments, the casing 40 can contain the pump 32 and the turbine 34. Furthermore, the casing 40 can be split into separate pieces, for example, the casing 40 can include a first casing portion 42 and a second casing portion 44 (see FIG. 3). The plate 38 of the engine 14 can be fixed to the output shaft 18 through the casing 40, and more specifically, through the first casing portion 42. Therefore, rotation of the output shaft 18 from operation of the engine 14 can be directed through the plate 38 (or flywheel) of the engine 14, and this rotation is then directed through the first casing portion 42 of the isolator assembly 12 via the plate 38 (or flywheel). It is to be appreciated that FIG. 3 illustrates some of the parts of the isolator assembly 12/the torque converter for illustrative purposes, and other parts, not illustrated, can be included inside the casing 40.

The second casing portion 44 can house at least part of the pump 32. Movement of the second casing portion 44 causes movement of the pump 32. The first casing portion 42 can be fixed to the plate 38 of the engine 14 by one or more fastener, such as a bolt, a pin, etc., or welded thereto. The second casing portion 44 can be fixed (either directly or indirectly) to the first casing portion 42 by one or more fastener, such as a bolt, a pin, etc., or welded thereto. The pump 32 is rotatable with the plate 38 of the engine 14 through the casing 40. Therefore, the plate 38 of the engine 14, the output shaft 18 and the pump 32 are rotatable concurrently. As such, the pump 32 rotates at the same speed as the output shaft 18. Rotation of the pump 32 causes the fluid inside the pump 32 to move toward the turbine 34. Movement of the fluid into the turbine 34 from the pump 32 causes the turbine 34 to rotate. As such, the pump 32 and the turbine 34 are fluidly connected to each other. The pump 32 is rotatable to transfer torque through the turbine 34. The turbine 34 can rotate at the same speed or a different speed from the pump 32, which is discussed further below.

Referring to FIG. 2, the isolator assembly 12 includes a clutch 46. The operable location of the clutch 46 can be changed depending on the type of transmission 16 being utilized. Therefore, the clutch 46 can be in different locations. In various embodiments when the torque converter is eliminated, the inertia structure 31 is disposed downstream of the clutch 46 relative to the direction that torque is transferred across the isolator assembly. In certain embodiments when utilizing the torque converter, the clutch 46 can be operable between the pump 32 and the turbine 34. The clutch 46 can mechanically couple the pump 32 and turbine 34 together. As non-limiting examples, as shown in FIG. 2, the pump 32 can be operable upstream from the clutch 46 relative to the direction that torque is transferred across the isolator assembly 12. It is to be appreciated that in various embodiments, the clutch 46 can be disposed inside the casing 40.

Generally, the clutch 46 is configured to operate in a full locked condition. Therefore, regardless of whether the torque converter is being utilized, the clutch 46 is operable in the full locked condition. When the torque converter is eliminated, the clutch 46 indirectly or directly locks the inertia structure 31 to the output shaft 18 of the engine 14 when in the full locked condition.

In the torque converter application, the clutch 46 is also configured to operate in a slip condition. As such, for the torque converter application, in the full locked condition, the clutch 46 can operate to lock the pump 32 and the turbine 34 together. Therefore, the full locked condition allows the pump 32 and the turbine 34 to rotate at the same speed. Said differently, the clutch 46 locks the pump 32 and the turbine 34 together when in the full locked condition, i.e., mechanically connects the pump 32 and the turbine 34. More specifically, the clutch 46 can indirectly or directly lock the pump 32 and the turbine 34 together when in the full locked condition. As such, the clutch 46 can operate to prevent slip between the pump 32 and the turbine 34.

Continuing with the torque converter application, in the slip condition, the clutch 46 can operate to allow slip between the pump 32 and the turbine 34. Therefore, the pump 32 and the turbine 34 can rotate at different speeds when the clutch 46 is in the slip condition. As such, in the slip condition, the clutch 46 partially connects the pump 32 and the turbine 34 mechanically. The clutch 46 can be adjustable to change an amount of pressure clamping together friction plates 38. Therefore, depending on the desired amount of slip between the pump 32 and the turbine 34, the amount of pressure that clamps the friction plates 38 together can be changed by a solenoid of the clutch 46 to allow the pump 32 and the turbine 34 to slip relative to each other.

Additionally, the clutch 46 can be configured to operate in an open condition, in which the clutch 46 is disengaged. Therefore, regardless of whether the torque converter is being utilized, the clutch 46 is operable in the open condition. When the clutch 46 is in the open condition when the torque converter is eliminated, the inertia structure 31 is not locked to the output shaft 18 of the engine 14. For the torque converter application, in the open condition, the pump 32 and the turbine 34 operate through the fluid coupling 36. Therefore, the pump 32 and the turbine 34 are not locked together by the clutch 46. In other words, the clutch 46 is not being operated when in the open condition.

Referring to FIG. 2, the isolator assembly 12 includes a first damper 48 and a second damper 50 configured to reduce oscillation when the clutch 46 is in the full locked condition. Therefore, the first and second dampers 48, 50 can reduce oscillations when the clutch 46 is in the full locked condition. Furthermore, in certain embodiments, the first and second dampers 48, 50 can be configured to reduce oscillation when the clutch 46 is in one of the full locked condition and the slip condition. As such, the clutch 46 indirectly or directly locks the first and second dampers 48, 50 together to rotate at the same speed when in the full locked condition. In various embodiments, the clutch 46 is operable in the full locked condition in which the clutch 46 indirectly locks the pump 32 and the turbine 34 together through the first and second dampers 48, 50 such that the pump 32 and the turbine 34 rotate at the same speed. Furthermore, the first and second dampers 48, 50 can reduce oscillations when the clutch 46 is in the slip condition. As such, when the clutch 46 is in the slip condition, the first and second dampers 48, 50 can rotate at different speeds.

When the inertia structure 31 includes the turbine 34, FIG. 2 illustrates schematically the turbine 34 with various suitable connection locations in phantom lines (dash-dot-dot-dash lines). The turbine 34 can be connected to various components in the three different locations illustrated, i.e., one or the other of the first damper 48, the second damper 50 and the end plate 56, not two or three of these locations at the same time. Furthermore, the first and second dampers 48, 50 can be operable in a series circuit arrangement. Said differently, the first and second dampers 48, 50 are disposed in a series circuit arrangement relative to each other. In certain embodiments, the clutch 46 and the first and second dampers 48, 50 are disposed in the series circuit arrangement. In the vehicle application, the output shaft 18, the first and second dampers 48, 50 and the input member 20 can be disposed in the series circuit arrangement relative to each other. The connection locations of the turbine 34 are discussed further below.

Generally, the first and second dampers 48, 50 can be configured to reduce oscillation from operation of the engine 14. More specifically, the first and second dampers 48, 50 are configured to reduce oscillation from operation of the engine 14 to the input member 20 of the transmission 16 when the clutch 46 is in the full locked condition or the slip condition. In certain embodiments, the first and second dampers 48, 50 can be configured to reduce oscillation from the pump 32 toward the turbine 34. As such, oscillations from the engine 14 are transferred to the first and second dampers 48, 50, (and through the pump 32 when utilized), and the dampers 48, 50 reduce those oscillations. Simply stated, the first and second dampers 48, 50 can dampen oscillations from the engine 14, which thus reduces the amount of oscillations being transferred to the input member 20 of the transmission 16.

Referring to FIGS. 2 and 3, the first and second dampers 48, 50 each include at least one plate 52 and at least one spring 54. The plate 52 of the first and second dampers 48, 50 can be directly coupled to the input member 20 of the transmission 16. In certain embodiments, the at least one spring 54 includes a plurality of springs 54, with each of the first and second dampers 48, 50 including more than one of the springs 54. The springs 54 can act as dynamic absorbers to absorb oscillations or inertia from the engine 14. Therefore, the first and second dampers 48, 50 can also be referred to as dynamic dampers.

Furthermore, the spring(s) 54 can be further defined as a coil spring 54. As discussed above, FIG. 3 illustrates some of the parts of the isolator assembly 12/the torque converter for illustrative purposes, and the illustrated damper can represent either of the first and second dampers 48, 50; and for the present disclosure, the casing 40 can be enlarged to include both the first and second dampers 48, 50, having the illustrated plate 52 and the spring(s) 54.

Continuing with FIG. 2, the isolator assembly 12 can include an end plate 56 disposed downstream from the first and second dampers 48, 50 relative to the direction that torque is transferred across the isolator assembly 12. As best shown in FIG. 2, the end plate 56 can be directly coupled to the input member 20 (of the transmission 16).

Continuing with FIG. 2, the inertia structure 31 can be disposed either upstream or downstream from the clutch 46 depending on the desired application. For example, when utilizing the torque converter, the inertia structure 31 can be disposed upstream from the clutch 46 relative to the direction that torque is transferred across the isolator assembly 12 or downstream from the clutch 46 relative to the direction that torque is transferred across the isolator assembly 12. When the torque converter is eliminated, the inertia structure 31 can be disposed downstream from the clutch 46 relative to the direction that torque is transferred across the isolator assembly 12.

Again continuing with FIG. 2, the inertia structure 31 can be coupled to one of the first damper 48, the second damper 50 and the end plate 56, i.e., one or the other, not two or three of these locations at the same time. Therefore, in one embodiment, the inertia structure 31 can be coupled to the first damper 48. For example, the inertia structure 31 can be coupled to the plate 52 of the first damper 48. In another embodiment, the inertia structure 31 can be coupled to the second damper 50. For example, the inertia structure 31 can be coupled to the plate 52 of the second damper 50. In yet another embodiment, the inertia structure 31 can be coupled to the end plate 56.

The inertia structure 31 can be different depending on the type of transmission being utilized. For example, the inertia structure 31 can include part of the torque converter, and specifically the turbine 34 of the torque converter, when utilizing an automatic transmission, automated manual transmission or a CVT. As another example, the inertia structure 31 can include a plate 57 when utilizing a dual-clutch transmission or a manual transmission. Therefore, the torque converter can be eliminated for the dual-clutch transmission or the manual transmission, and thus, the plate 57 of the inertia structure 31 is utilized instead of the torque converter, and thus instead of the pump 32 and the turbine 34. Said differently, if utilizing the plate 57, then the torque converter is eliminated; and if utilizing the torque converter, then the plate 57 is eliminated.

When the inertia structure 31 includes the plate 57, the plate 57 can be coupled to one of the first damper 48, the second damper 50 and the end plate 56. Therefore, in one embodiment, the plate 57 of the inertia structure 31 can be coupled to the first damper 48. For example, the plate 57 of the inertia structure 31 can be coupled to the plate 52 of the first damper 48. In another embodiment, the plate 57 of the inertia structure 31 can be coupled to the second damper 50. For example, the plate 57 of the inertia structure 31 can be coupled to the plate 52 of the second damper 50. In yet another embodiment, the plate 57 of the inertia structure 31 can be coupled to the end plate 56.

When the inertia structure 31 includes the turbine 34, the turbine 34 can be coupled to one of the first damper 48, the second damper 50 and the end plate 56. Therefore, in one embodiment, the turbine 34 can be coupled to the first damper 48. For example, the turbine 34 can be coupled to the plate 52 of the first damper 48. In another embodiment, the turbine 34 can be coupled to the second damper 50. For example, the turbine 34 can be coupled to the plate 52 of the second damper 50. In yet another embodiment, the turbine 34 can be coupled to the end plate 56.

Continuing with FIG. 2, the isolator assembly 12 includes a centrifugal pendulum absorber (CPA) 58 that is configured to reduce oscillation when the clutch 46 is in the full locked condition. By utilizing the CPA 58 configurations discussed herein, the engine speed 22, in which the clutch 46 can operate in the full locked condition, can be reduced as compared to configurations that do not use a CPA. For example, the engine speed 22 can be reduced from 1100 revolutions per minute (rpm) to 1000 rpm. Furthermore, in certain embodiments, the CPA 58 can be configured to reduce oscillation when the clutch 46 is in one of the full locked condition and the slip condition. Therefore, the CPA 58 can reduce oscillations when the clutch 46 is in the full locked condition. Additionally, in certain embodiments, the CPA 58 can reduce oscillations when the clutch 46 is in the slip condition.

Additionally, the CPA 58 is configured to cancel sound at a certain frequency due to the operation of the engine 14. The CPA 58 is tuned to a desired firing order of the engine 14 to absorb vibrations that produce sound at a certain frequency. Generally, the engine speed 22 is greater than a predetermined threshold for the CPA 58 to absorb vibrations that produce sound at the certain frequency.

FIG. 2 illustrates schematically the CPA 58 with various suitable connection locations in phantom lines (dash-dot-dot-dash lines). The CPA 58 can be connected to various components in the three different locations illustrated. The CPA 58 is coupled to one of the first and second dampers 48, 50. In certain embodiments, the CPA 58 can be directly coupled to one of the first and second dampers 48, 50, and in other embodiments, the CPA 58 can be indirectly coupled to one of the first and second dampers 48, 50. Therefore, in certain embodiments, the CPA 58 is directly coupled to the plate 52 of the first damper 48 upstream from the second damper 50 relative to the direction that torque is transferred across the isolator assembly 12; and in this embodiment, the second damper 50 is spaced from the CPA 58. In other embodiments, the CPA 58 is directly coupled to the plate 52 of the second damper 50 downstream from the first damper 48 relative to the direction that torque is transferred across the isolator assembly 12; and in this embodiment, the first damper 48 is spaced from the CPA 58. In yet another embodiment, the CPA 58 is directly coupled to the end plate 56; and in this embodiment, the first and second dampers 48, 50 are spaced from the CPA 58.

Referring to FIG. 4, the CPA(s) 58 can include a central support 60 and a weight member 62 coupled to the central support 60. In certain embodiments, the central support 60 can be coupled to the input member 20 of the transmission 16. The weight member 62 is movable back and forth (see arrow 64 in FIG. 4) relative to the central support 60, which reduces oscillation from the engine 14 toward the transmission 16. The weight member 62 can be disposed on both sides of the central support 60. In certain embodiments, the CPA(s) 58 can include a plurality of weight members 62 spaced from each other, and each of the weight members 62 can be configured the same or differently or combinations thereof.

Furthermore, in various embodiments, more than one CPA 58 can be utilized. Therefore, any combination of two CPAs 58 utilizing the three different locations illustrated in FIG. 2 can be suitable, i.e., one CPA 58 coupled to the first damper 48 and another CPA 58 coupled to the second damper 50, or one CPA 58 coupled to the first damper 48 and another CPA 58 coupled to the end plate 56, or one CPA 58 coupled to the second damper 50 and another CPA 58 coupled to the end plate 56, etc.

In addition, three CPAs 58 can be utilized, with one CPA 58 directly coupled to the three different locations illustrated in FIG. 2. For example, the CPA 58 can be further defined as a first CPA 58A, and the isolator assembly 12 can further include a second CPA 58B spaced from the first CPA 58A. The first CPA 58A can be directly coupled to the plate 52 of the first damper 48 upstream from the second damper 50 relative to the direction that torque is transferred across the isolator assembly 12, and the second CPA 58B can be directly coupled to the plate 52 of the second damper 50 downstream from the first damper 48 relative to the direction that torque is transferred across the isolator assembly 12. The isolator assembly 12 can also include a third CPA 58C spaced from the first and second CPAs 58A, 58B, and the third CPA 58C can be directly coupled to the end plate 56. The casing 40 can house the pump 32, the turbine 34, the first and second dampers 48, 50, one or more of the CPA(s) 58, 58A, 58B, 58C and the clutch 46.

When utilizing the torque converter, the turbine 34 can be connected to various components in different various locations as briefly discussed above. For example, the turbine 34 can be coupled to the plate 52 of one of the first and second dampers 48, 50. Therefore, for example, in one embodiment, the turbine 34 can be coupled to the plate 52 of the first damper 48. In another embodiment, the turbine 34 can be coupled to the plate 52 of the second damper 50. In yet another embodiment, the turbine 34 can be coupled to the end plate 56.

As shown in FIG., optionally, the isolator assembly 12 can include one or more springs 65 disposed downstream from the turbine 34 (when utilizing the torque converter) or disposed downstream from the plate 57 (when eliminating the torque converter). When utilizing the torque converter, one or more of the springs 65 can be disposed between the turbine 34 and one of the first damper 48, the second damper 50 and the end plate 56. When the torque converter is eliminated, one or more of the springs 65 can be disposed between the plate 57 and one of the first damper 48, the second damper 50 and the end plate 56. Therefore, if utilizing the pump 32 and the turbine 34, then the plate 57 is not utilized. If utilizing the plate 57, then the pump 32 and the turbine 34 are eliminated. As such, both embodiments can utilize one or more of the springs 65. The spring(s) 65 can act as dynamic absorbers to absorb oscillations or inertia from the engine 14 or the turbine 34.

The clutch 46 can be disposed upstream from the first and second dampers 48, 50 and the CPA(s) 58, 58A, 58B, 58C relative to the direction that torque is transferred across the isolator assembly 12. When the clutch 46 is operable in the full locked condition, the clutch 46 indirectly or directly locks together the first and second dampers 48, 50 and one or more of the CPA(s) 58, 58A, 58B, 58C such that these components rotate at the same speed.

A controller 66 can be in electrical communication with the isolator assembly 12, the engine 14 and/or the transmission 16. In certain embodiments, the controller 66 is in electrical communication with the clutch 46, and more specifically, with the solenoid of the clutch 46 which operates to control the amount of pressure applied to the friction plates 38. Therefore, for example, the controller 66 can control which condition the clutch 46 is in, i.e., the full locked condition and the slip condition. When in the slip condition, the controller 66 can control the amount of slip between the pump 32 and the turbine 34. Instructions can be stored in a memory 68 of the controller 66 and automatically executed via a processor 70 of the controller 66 to provide the respective control functionality.

The controller 66 is configured to execute the instructions from the memory 68, via the processor 70. For example, the controller 66 can be a host machine or distributed system, e.g., a computer such as a digital computer or microcomputer, and, as the memory 68, tangible, non-transitory computer-readable memory such as read-only memory (ROM) or flash memory. The controller 66 can also have random access memory (RAM), electrically erasable programmable read-only memory (EEPROM), a high-speed clock, analog-to-digital (A/D) and/or digital-to-analog (D/A) circuitry, and any required input/output circuitry and associated devices, as well as any required signal conditioning and/or signal buffering circuitry. Therefore, the controller 66 can include all software, hardware, memory 68, algorithms, connections, sensors, etc., necessary to control, for example, the clutch 46. As such, a control method operative to control the clutch 46, can be embodied as software or firmware associated with the controller 66. It is to be appreciated that the controller 66 can also include any device capable of analyzing data from various sensors, comparing data, making the necessary decisions required to control and/or monitor the clutch 46, the isolator assembly 12, the engine 14 and/or the transmission 16. Optionally, more than one controller 66 can be utilized.

While the best modes and other embodiments for carrying out the disclosure have been described in detail, those familiar with the art to which this disclosure relates will recognize various alternative designs and embodiments for practicing the disclosure within the scope of the appended claims. Furthermore, the features shown in the drawings or the characteristics of various features mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. An isolator assembly comprising:
a clutch configured to operate in a full locked condition;
a first damper and a second damper configured to reduce oscillation when the clutch is in the full locked condition, wherein the first and second dampers each include at least one plate and at least one spring; and
a centrifugal pendulum absorber (CPA) coupled to one of the first and second dampers, and the CPA is configured to reduce oscillation when the clutch is in the full locked condition.

2. The assembly as set forth in claim 1 wherein the first and second dampers are disposed in a series circuit arrangement relative to each other.

3. The assembly as set forth in claim 2 further including:
an end plate disposed downstream from the first and second dampers relative to the direction that torque is transferred across the isolator assembly;
an inertia structure coupled to one of the first damper, the second damper and the end plate; and
the inertia structure dampens oscillation when torque is transferred across the isolator assembly.

4. The assembly as set forth in claim 3:
further including a pump;
wherein the inertia structure includes a turbine fluidly connected to the pump;
wherein the pump is operable upstream from the clutch relative to the direction that torque is transferred across the isolator assembly;
wherein the turbine is coupled to the plate of one of the first and second dampers;
wherein the clutch is also configured to operate in a slip condition;
wherein the first damper and the second damper are configured to reduce oscillation when the clutch is in one of the full locked condition and the slip condition; and
wherein the CPA is configured to reduce oscillation when the clutch is in one of the full locked condition and the slip condition.

5. The assembly as set forth in claim 3:
further including a pump;
wherein the inertia structure includes a turbine fluidly connected to the pump;
wherein the pump is operable upstream from the clutch relative to the direction that torque is transferred across the isolator assembly;
wherein the turbine is coupled to the end plate;
wherein the clutch is also configured to operate in a slip condition;
wherein the first damper and the second damper configured to reduce oscillation when the clutch is in one of the full locked condition and the slip condition; and
wherein the CPA is configured to reduce oscillation when the clutch is in one of the full locked condition and the slip condition.

6. The assembly as set forth in claim 5 wherein the pump and the turbine are rotatable at different speeds when the clutch is in the slip condition, and wherein the clutch is operable in the full locked condition in which the clutch indirectly or directly locks the pump and the turbine together such that the pump and the turbine rotate at the same speed.

7. The assembly as set forth in claim 1 wherein the CPA is directly coupled to the plate of the first damper upstream from the second damper relative to the direction that torque is transferred across the isolator assembly, and wherein the second damper is spaced from the CPA.

8. The assembly as set forth in claim 7 wherein the CPA is further defined as a first CPA, and further including a second CPA spaced from the first CPA, and wherein the first CPA is directly coupled to the plate of the first damper upstream from the second damper relative to the direction that torque is transferred across the isolator assembly, and the second CPA is directly coupled to the plate of the second damper downstream from the first damper relative to the direction that torque is transferred across the isolator assembly.

9. The assembly as set forth in claim 8 further including a third CPA spaced from the first and second CPAs, and further including an end plate disposed downstream from the first and second dampers relative to the direction that torque is transferred across the isolator assembly, and wherein the third CPA is directly coupled to the end plate.

10. The assembly as set forth in claim 1 wherein the CPA is directly coupled to the plate of the second damper downstream from the first damper relative to the direction that torque is transferred across the isolator assembly, and wherein the first damper is spaced from the CPA.

11. The assembly as set forth in claim 1 further including an end plate disposed downstream from the first and second dampers relative to the direction that torque is transferred across the isolator assembly, and wherein the CPA is directly coupled to the end plate, and wherein the first and second dampers are spaced from the CPA.

12. A vehicle comprising:
an engine including an output shaft;
a transmission including an input member;
an isolator assembly operable between the output shaft and the input member, wherein the isolator assembly comprises:
a clutch configured to operate in a full locked condition;
a first damper and a second damper configured to reduce oscillation when the clutch is in the full locked condition, and wherein the first and second dampers each include at least one plate and at least one spring; and
a centrifugal pendulum absorber (CPA) coupled to one of the first and second dampers, and the CPA is configured to reduce oscillation when the clutch is in the full locked condition.

13. The vehicle as set forth in claim 12 wherein the output shaft, the first and second dampers and the input member are disposed in a series circuit arrangement relative to each other.

14. The vehicle as set forth in claim 13 wherein the CPA is directly coupled to the plate of the first damper upstream from the second damper relative to the direction that torque is transferred across the isolator assembly, and wherein the second damper is spaced from the CPA.

15. The vehicle as set forth in claim 13 wherein the CPA is directly coupled to the plate of the second damper downstream from the first damper relative to the direction that torque is transferred across the isolator assembly, and wherein the first damper is spaced from the CPA.

16. The vehicle as set forth in claim 13 wherein the isolator assembly includes an end plate disposed downstream from the first and second dampers relative to the direction that torque is transferred across the isolator assembly, and wherein the end plate is directly coupled to the input member, and the CPA is directly coupled to the end plate, and wherein the first and second dampers are spaced from the CPA.

17. The vehicle as set forth in claim 12 wherein:
the isolator assembly includes an end plate disposed downstream from the first and second dampers relative to the direction that torque is transferred across the isolator assembly;
the isolator assembly includes an inertia structure coupled to one of the first damper, the second damper and the end plate; and
the inertia structure dampens oscillation when torque is transferred across the isolator assembly.

18. The vehicle as set forth in claim 17 wherein:
the isolator assembly includes a pump and a turbine fluidly connected to the pump;
the pump is operable upstream from the clutch relative to the direction that torque is transferred across the isolator assembly;
the isolator assembly includes an end plate disposed downstream from the first and second dampers relative to the direction that torque is transferred across the isolator assembly; and
the inertia structure includes the turbine that is coupled to one of the first damper, the second damper and the end plate;
the turbine is coupled to the plate of one of the first and second dampers;
the clutch is also configured to operate in a slip condition;
the first damper and the second damper are configured to reduce oscillation when the clutch is in one of the full locked condition and the slip condition; and
the CPA is configured to reduce oscillation when the clutch is in one of the full locked condition and the slip condition.

19. The vehicle as set forth in claim 12 wherein the CPA is further defined as a first CPA, and the isolator assembly includes a second CPA spaced from the first CPA, and wherein the first CPA is directly coupled to the plate of the first damper upstream from the second damper relative to the direction that torque is transferred across the isolator assembly, and the second CPA is directly coupled to the plate of the second damper downstream from the first damper relative to the direction that torque is transferred across the isolator assembly.

20. The vehicle as set forth in claim 19 wherein the isolator assembly includes a third CPA spaced from the first and second CPAs, and includes an end plate disposed downstream from the first and second dampers relative to the direction that torque is transferred across the isolator assembly, and wherein the third CPA is directly coupled to the end plate.
